(19) United States
(12) Patent Application Publication
(10) Pub. No.: US 2025/0132691 A1
(43) Pub. Date: Apr. 24, 2025

(54) Method of operating an inverter circuit, inverter control unit and inverter arrangement

(71) Applicant: SEG Automotive Germany GmbH, Stuttgart (DE)

(72) Inventors: Arunkumar MOTAGANAHALLI SRINIVASAMURTHY, Stuttgart (DE); Kaan AKBULUT, Stuttgart (DE); Murugaperumal DEVARAJA, Stuttgart (DE)

(21) Appl. No.: 18/919,205

(22) Filed: Oct. 17, 2024

(30) Foreign Application Priority Data
Oct. 20, 2023 (DE) 102023128896.2

(51) Int. Cl. H02M 7/537; H02M 1/00; H02M 1/32

(52) U.S. Cl. CPC H02M 7/537; H02M 1/32; H02M 1/0009

(57) ABSTRACT

An inverter circuit has a low side which has a plurality of controllable semiconductor switching elements connected in parallel with one another between a first DC voltage terminal and a center terminal of the inverter circuit, and a high side which has a plurality of controllable semiconductor switching elements connected in parallel with one another between a second DC voltage terminal and the center terminal of the inverter circuit. The inverter circuit also has a first current sensor, connected in series with exactly one of the switching elements and adapted to measure a first current which flows through the switching element, and a second current sensor, arranged between the center terminal and an output terminal of the inverter circuit and adapted to measure a second current. The first current and the second current are recorded. The second current is then checked for plausibility with the first current.

### CROSS-REFERENCE TO RELATED APPLICATIONS

This application claims priority to German Patent Application No. 102023128896.2 filed Oct. 20, 2023 which is hereby incorporated by reference in its entirety.

### TECHNICAL FIELD

The present disclosure relates to a method of operating an inverter circuit, an inverter control unit and an inverter arrangement.

### BACKGROUND

Inverter or power converter circuits are electrical circuits for converting one type of electrical current into another type of current, i.e. for example from a direct current into an alternating current or vice versa. For this purpose, one or more half-bridges connected in parallel can be used in inverter circuits, wherein a half-bridge comprises two semiconductor switching elements connected in series to a voltage source.

In an electric machine with a stator having multiple phase windings and a rotor, used for example in hybrid or all-electric vehicles, the measurement of a current through one or more phase windings (hereinafter also referred to as phase current) is used to control the momentary torque on the shaft of the electric machine and to estimate the torque for monitoring purposes.

In order to fulfill functional safety requirements with regard to torque control, the phase current measurement or the integrity of the sensors must be monitored. There are concepts for monitoring the phase current measurement by using redundant measurement or estimation concepts. This redundancy can be achieved by using more than one phase current sensor per phase winding for each of the phase windings.

### SUMMARY

According to the disclosure, a method of operating an inverter circuit, an inverter control unit and an inverter arrangement with the features of the independent patent claims are proposed.

Advantageous embodiments are the subject of the dependent claims and the following description.

The disclosure is based on an inverter circuit with a low-side, which has a plurality of controllable semiconductor switching elements which are connected in parallel to one another between a first DC voltage terminal and a center terminal of the inverter circuit, and a high-side, which also has a plurality of controllable semiconductor switching elements which are connected in parallel to one another between a second DC voltage terminal and the center terminal. The inverter circuit is adapted in particular to supply phase windings of an electrical machine with an output current via the center terminal.

In the disclosure, the redundancy of the current sensors is achieved by one of the current sensors measuring the current through only one semiconductor switching element and a second of the current sensors measuring the current through all semiconductor switching elements connected in parallel on the high or low side.

Due to the parallel connection, a lower current flows through just one semiconductor switching element than through the parallel-connected semiconductor switching elements together, which means that this built-in current sensor needs to have a smaller measuring range and is therefore more cost-effective.

Furthermore, the different measuring ranges make it easier and more cost-effective to use different sensor concepts.

In addition, a failure of one sensor has no effect on the redundant sensor, as these are located at different points in the circuit.

Specifically, the inverter circuit has a first current sensor that is connected in series with exactly one of the controllable semiconductor switching elements and is adapted to measure a first current that flows through said one of the controllable semiconductor switching elements. The first current sensor can, for example, be arranged in the high side or the low side. It can be arranged between the respective DC voltage terminal and the semiconductor switching element, or between the semiconductor switching element and the center terminal.

Furthermore, the inverter circuit has a second current sensor, for example an in-line/phase current sensor, which is arranged between the center terminal and an output terminal of the inverter circuit and is adapted to measure a second current. The second current is, in particular, a current that flows through the entire active high or low side of the inverter circuit. The output terminal is used to connect a load, for example a phase winding of an electrical machine.

In the method, the first current measured by the first current sensor and the second current measured by the second current sensor are recorded.

The second current is then checked for plausibility with the first current and vice versa. In particular, a reference current can be determined from the first current for this purpose. Since the first current is only measured in one branch of the parallel-connected controllable semiconductor switching elements, the measured current is lower than the second current. To compensate for this structural difference, the first current must first be converted in order to be comparable with the second current. If only a single first current sensor is used in a branch, the reference current can be determined in particular by multiplying the measured current by the number of controllable semiconductor switching elements of the affected high or low side.

The reference current can then be compared with the second current in order to determine a difference between the two currents, the second current and the reference current, and, if the determined difference is above a predetermined threshold value, to determine that a fault is present. In particular, the maxima of the reference current waveform and the second current waveform can be compared with each other, which can save computing power in the computing unit performing the method. However, an ongoing comparison can also take place, wherein care must be taken to ensure that the first and second currents are measured at the same points in time.

The error may be, for example, that the first current sensor is defective or that an error has occurred when determining the second current, for example because the second current sensor is defective. The fault may also be that one of the semiconductor switching elements is defective, for example because the semiconductor switching element is permanently open.

If a fault is determined in the inverter arrangement, the inverter arrangement can be transferred to a safe state in particular.

By arranging the current sensors and checking the plausibility of the currents with each other, the highest functional safety standards according to ASIL-C and ASIL-D (ISO26262) can be achieved in a cost-effective manner and the aforementioned advantages can also be achieved.

The disclosure also relates to an inverter control unit which is adapted, in particular in terms of programming, to carry out all the process steps of a method according to the disclosure.

The disclosure also relates to an inverter arrangement comprising an inverter control unit according to the disclosure and an inverter circuit as described in this application, which is controlled by the inverter control unit.

The disclosure proposes an inverter arrangement that meets the highest functional safety standards in a simple and cost-effective manner and achieves the aforementioned benefits.

In embodiments, the controllable semiconductor switching elements are in particular transistors, for example metal oxide semiconductor field effect transistors (MOSFET), in particular silicon carbide, SiC, MOSFETs, or insulated-gate bipolar transistors (IGBT).

In embodiments, the inverter circuit has several first current sensors. A number of first current sensors corresponds in particular to a number of the first semiconductor switching elements of the low or high side. Each first current sensor is connected in series with a different one of the controllable semiconductor switching elements, in particular of the same high or low side, and thus measures the first current flowing through the respective controllable semiconductor switching element. In other words, each first current sensor is arranged in a different branch of the parallel-connected controllable semiconductor switching elements on the low or high side. In this case, the reference current is determined as a function of each input current measured by the plurality of first current sensors, for example by forming a sum of the first currents.

By using a large number of first current sensors, in particular a first current sensor in each branch of a side, it is possible to determine exactly which semiconductor switching element is defective in the event of a fault, thus simplifying maintenance.

In embodiments, a measuring range of the first current sensor or each of the first current sensors corresponds to at least a quotient of the measuring range of the second current sensor and a number of the controllable semiconductor switching elements. In particular, a buffer can be provided in the measuring range of the first current sensor, i.e. the measuring range, in particular an upper end of the measuring range or a maximum measurable current intensity, of the first current sensor can be selected larger than determined by the quotient in order to take account of a so-called “open circuit fault”, in which the current intensity through the branch or the current sensor is higher than the current measured in normal operation, and thus to prevent the current sensor or the current sensors from being damaged in the event of such a fault.

Further advantages and embodiments of the disclosure are shown in the description and the accompanying drawing.

The disclosure is illustrated schematically in the drawing by means of embodiment examples and is described below with reference to the drawing.

### BRIEF DESCRIPTION OF THE DRAWINGS

FIG. 1 shows a block diagram of an inverter arrangement which is adapted to carry out the method according to the disclosure, in embodiments.

FIG. 2 shows a flow chart of a method of operating an inverter circuit, in embodiments.

FIG. 3 shows a block diagram of a further inverter arrangement which is adapted to carry out a method of operating an inverter circuit, in embodiments.

### DETAILED DESCRIPTION

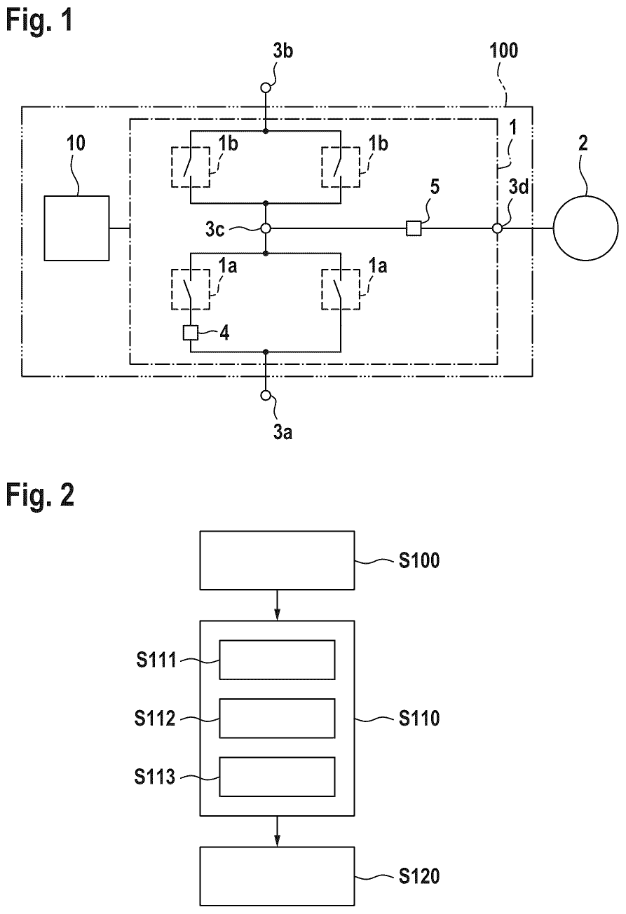

FIG. 1 shows a block diagram of an inverter arrangement 100, which is adapted to carry out a method according to the disclosure. FIG. 2 shows a flow diagram of an embodiment of the method according to the disclosure. In the following, both figures will be described together.

The inverter arrangement 100 has an inverter circuit 1 which has a high side and a low side as well as a center terminal 3c between the high side and the low side and an output terminal 3d connected to the center terminal 3c. A load can be connected to the output terminal 3d, for example a phase winding of an electrical machine 2. The present inverter circuit 1 is designed as a half-bridge circuit, whereby several such half-bridge circuits 1 can be part of the inverter arrangement 100 in order to connect a multi-phase AC voltage load, for example a multi-phase electrical machine, to a DC voltage network, for example an on-board network of a vehicle.

The low side here has two controllable semiconductor switching elements 1a, which are connected in parallel between a first DC voltage terminal 3a and the center terminal 3c of the inverter circuit 1. The first DC voltage terminal 3a can in particular be a ground connection. The high side here also has two controllable semiconductor switching elements 1b, which are connected in parallel between a second DC voltage terminal 3b and the center terminal 3c. The second DC voltage terminal 3b can in particular be connected to a DC voltage potential.

The controllable semiconductor switching elements 1a, 1b are connected to an inverter control unit 10 of the inverter arrangement 100. The inverter control unit 10 is adapted to control the controllable semiconductor switching elements 1a, 1b. It is understood that the high side and/or the low side can also have more than two parallel-connected controllable semiconductor switching elements, the number depending in particular on the maximum current carrying capacity.

The low side of the inverter circuit 1 also has a first current sensor 4 in a branch (here the left branch) of the parallel circuit, which is arranged between the first DC voltage terminal 3a and the left controllable semiconductor switching element 1a and is adapted to measure the current intensity of the first current flowing through the left controllable semiconductor switching element 1a. It should be noted that the first sensor 4 can also be arranged in series above the semiconductor switching element 1a (i.e. the between center terminal 3c and the semiconductor switching element 1a), or also in series with a semiconductor switching element 1b on the high side.

Furthermore, the inverter circuit 1 has a second current sensor 5, which is arranged between the center terminal 3c and the output terminal 3d and is adapted to measure the current intensity of the current flowing through the entire high or low side (i.e. the sum). This also corresponds to the current flowing through the connected load or, in this case, the phase winding of the electrical machine 2.

The measuring range, in particular the upper end of the measuring range, i.e. the maximum measurable current, of the first current sensor 4 corresponds in particular to at least a measuring range of the second current sensor 5 divided by a number of the controllable semiconductor switching elements 1a. The inverter circuit 1 shown in FIG. 1 has two controllable semiconductor switching elements 1a. The measuring range of the first current sensor 4 therefore corresponds to at least half of the measuring range of the second current sensor 5.

In the method, the first current measured by the first current sensor 4 and the second current measured by the second current sensor 5 are recorded in a step S100.

The second current is then checked for plausibility with the first current in block S110.

The plausibility check in block S110 initially comprises a step S111, in which a reference current is determined as a function of the first current. Since the first current sensor 4 only measures a part of the total current of the inverter circuit 1 due to the arrangement in the parallel circuit, a reference current is first determined from the first current, which can be compared with the second current. For example, the reference current can be determined by multiplying the measured first current by the number of controllable semiconductor switching elements 1a on the affected side (in this case the low side). In this case, the current intensity of the reference current therefore corresponds twice to the current intensity of the first current.

For example, a maximum current intensity of the reference current can be compared with the maximum current intensity of the second current, which are measured in a predefined time interval. This can save computing capacity in the inverter control unit 10 carrying out the method. The measurement of the maximum value is also more accurate. However, in principle, the values can be compared at any time as long as they are based on (essentially) simultaneously measured first and second currents.

A difference between the second current and the reference current is then determined in step S112.

If it is subsequently determined in step S113 that the difference between the second current and the reference current exceeds a predetermined threshold value, it is determined that there is a fault in the inverter circuit 1.

If it is determined in step S113 that there is a fault in the inverter circuit 1, the inverter circuit 1 is transferred to a safe state in step S120, in particular by the inverter control unit 10. For example, all controllable semiconductor switching elements 1a (i.e. of the low side) can be permanently closed or switched into a conducting state.

If the inverter arrangement 100 is used to control a multi-phase electrical machine 2 and therefore has several inverter circuits 1, a second current sensor 5 is preferably provided in all of the inverter circuits 1 or all but one. The second current of the inverter circuit 1 without a second current sensor 5 can be calculated from the second currents of the other inverter circuits 1, since the sum of the currents is known, e.g. results in zero.

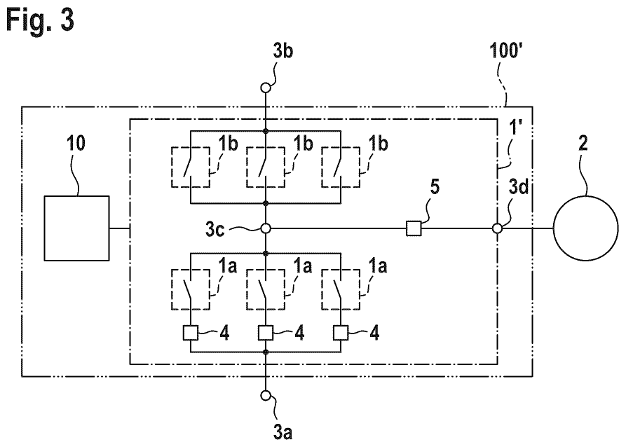

FIG. 3 shows a further embodiment of the inverter arrangement 100′, which is adapted to carry out a method according to the disclosure.

In contrast to the inverter arrangement 100 shown in FIG. 1, both the low side of the inverter circuit 1′ in FIG. 3 has three controllable semiconductor switching elements 1a and the high side of the inverter circuit 1′ has three controllable semiconductor switching elements 1b. Each of the controllable semiconductor switching elements 1a, 1b is connected to the inverter control unit 10 and is controlled by it.

Furthermore, the inverter circuit 1′ in the inverter arrangement 100′ has a first current sensor 4 in each branch of the parallel-connected controllable semiconductor switching elements 1a of the low side. Here, each branch has only one first current sensor 4, which is arranged between the first DC voltage terminal 3a and the corresponding first controllable semiconductor switching element 1a of the branch and is adapted to measure the current intensity of the first current flowing through the branch or the semiconductor switching element 1a. It should be noted that each first sensor 4 can also be arranged in series above the semiconductor switching element 1a (i.e. the between center terminal 3c and the semiconductor switching element 1a), or also in series with a semiconductor switching element 1b of the high side.

The method in the inverter arrangement 100′ is similar to the method previously described in relation to the inverter arrangement 100 of FIG. 1, so that only the differences will be explained below.

After the first currents and the second current have been recorded in step S100, a reference current is first determined in step S111 for plausibility checking in block S110. For this purpose, as explained with respect to the inverter arrangement 100, in embodiments of the disclosure the maximum of each first current is used. The reference current is thereby determined as the sum of all currents measured by the first current sensors 4.

If there are fewer first current sensors than semiconductor switching elements, the sum can be multiplied by a quotient of the number of controllable semiconductor switching elements 1a and the number of first current sensors. In the case of FIG. 3, this quotient is equal to 1, since there is one first current sensor 4 for each controllable semiconductor switching element 1a.

Subsequently, as set forth with respect to the inverter arrangement 100, in step S112, a difference between the reference current and the second current is determined, which is compared with a predetermined threshold value in step S113 and, if the difference is greater than the predetermined threshold value, it is determined that there is a fault in the inverter circuit 1.

If there is a fault in the inverter circuit 1, the inverter circuit 1 (and by this the electric machine 2) is transferred to a safe state by the inverter control unit 10 in step S120.

FIGS. 1 and 3 show examples of inverter circuits 1, 1′ with two or three controllable semiconductor switching elements per side. The disclosure is not intended to be limited to these examples, i.e. each of the high and low sides of the inverter circuit 1, 1′ can also have more than three semiconductor switching elements.

1. A method of operating an inverter circuit (1, 1′),
the inverter circuit (1, 1′) comprising
a low side, which has a plurality of controllable semiconductor switching elements (1a) which are connected in parallel with one another between a first DC voltage terminal (3a) and a center terminal (3c) of the inverter circuit (1, 1′),
a high side, which has a plurality of controllable semiconductor switching elements (1b) which are connected in parallel with one another between a second DC voltage terminal (3b) and the center terminal (3c) of the inverter circuit (1, 1′),
a first current sensor (4), which is connected in series with exactly one of the controllable semiconductor switching elements (1a, 1b) and is adapted to measure a first current which flows through the one of the controllable semiconductor switching elements (1a, 1b), and
a second current sensor (5), which is arranged between the center terminal (3c) and an output terminal (3d) of the inverter circuit (1, 1′) and is adapted to measure a second current,
the method comprising:
detecting (S100) the first current measured by the first current sensor (4) and the second current measured by the second current sensor (5),
plausibilizing (S110) the first current with the second current.

2. The method according to claim 1, wherein the plausibilizing (S110) the first current with the second current comprises:
determining (S111) a reference current as a function of the first current,
determining (S112) a difference between the second current and the reference current, and
determining (S113), if the difference exceeds a predetermined threshold value, that a fault is present in the inverter circuit (1, 1′).

3. The method according to claim 2, wherein the method further comprises:
transferring (S120), if the plausibility check (S110) shows that there is a fault in the inverter circuit (1, 1′), the inverter circuit (1, 1′) into a safe state.

4. The method according to claim 1, wherein the inverter circuit (1′) comprises a plurality of first current sensors (4), in particular a number of first current sensors (4) corresponding to a number of the controllable semiconductor switching elements (1a, 1b) of the low side or the high side,
wherein each of the plurality of first current sensors (4) is connected in series with a different one of the controllable semiconductor switching elements (1a, 1b),
wherein the reference current is determined as a function of each first current measured by the plurality of first current sensors (4).

5. The method according to claim 4, wherein a measuring range of each of the plurality of first current sensors (4) corresponds to at least a measuring range of the second current sensor (5) divided by a number of the controllable semiconductor switching elements (1a, 1b) of the low side or the high side.

6. The method according to claim 1, wherein a measuring range of the first current sensor (4) corresponds to at least a measuring range of the second current sensor (5) divided by a number of the controllable semiconductor switching elements (1a, 1b) of the low side or the high side.

7. An inverter control unit (10) for controlling an inverter circuit (1, 1′),
the inverter circuit (1, 1′) comprising
a low side, which has a plurality of controllable semiconductor switching elements (1a) which are connected in parallel with one another between a first DC voltage terminal (3a) and a center terminal (3c) of the inverter circuit (1, 1′),
a high side, which has a plurality of controllable semiconductor switching elements (1b) which are connected in parallel with one another between a second DC voltage terminal (3b) and the center terminal (3c) of the inverter circuit (1, 1′),
a first current sensor (4), which is connected in series with exactly one of the controllable semiconductor switching elements (1a, 1b) and is adapted to measure a first current which flows through the one of the controllable semiconductor switching elements (1a, 1b), and
a second current sensor (5), which is arranged between the center terminal (3c) and an output terminal (3d) of the inverter circuit (1, 1′) and is adapted to measure a second current,
wherein the inverter control unit (10) is adapted to:
detect (S100) the first current measured by the first current sensor (4) and the second current measured by the second current sensor (5),
plausibilize (S110) the first current with the second current.

8. An inverter arrangement (100, 100′) comprising an inverter control unit (10) according to claim 7 and at least one inverter circuit (1, 1′), the at least one inverter circuit (1, 1′) comprising:
a low side, which has a plurality of controllable semiconductor switching elements (1a) which are connected in parallel with one another between a first DC voltage terminal (3a) and a center terminal (3c) of the inverter circuit (1, 1′),
a high side, which has a plurality of controllable semiconductor switching elements (1b) which are connected in parallel with one another between a second DC voltage terminal (3b) and the center terminal (3c) of the inverter circuit (1, 1′),
a first current sensor (4), which is connected in series with exactly one of the controllable semiconductor switching elements (1a, 1b) and is adapted to measure a first current which flows through the one of the controllable semiconductor switching elements (1a, 1b), and
a second current sensor (5), which is arranged between the center terminal (3c) and an output terminal (3d) of the inverter circuit (1, 1′) and is adapted to measure a second current.

9. An inverter arrangement (100′) according to claim 8, wherein the inverter circuit (1′) comprises a plurality of first current sensors (4), in particular a number of first current sensors (4) corresponding to a number of the controllable semiconductor switching elements (1a) of the low or high side,
wherein each of the plurality of first current sensors (4) is connected in series with another one of the controllable semiconductor switching elements (1a, 1b).

10. The inverter arrangement (100, 100′) according to claim 8, wherein the controllable semiconductor switching elements (1a, 1b) are transistors, in particular metal-oxide-semiconductor field-effect transistors or insulated-gate bipolar transistors.
